(19) United States
(12) Patent Application Publication
(10) Pub. No.: US 2008/0038948 A1
(43) Pub. Date: Feb. 14, 2008

(54) Dummy plug for option device electric connector in heavy construction equipment

(75) Inventor: Tae Yeon Kim, Changwon (KR)

Correspondence Address: LADAS & PARRY, 26 WEST 61ST STREET, NEW YORK, NY, 10023, US

(73) Assignee: VOLVO CONSTRUCTION EQUIPMENT HOLDING SWEDEN AB.

(21) Appl. No.: 11/818,551

(22) Filed: Jun. 14, 2007

(30) Foreign Application Priority Data
Aug. 9, 2006 (KR) 10-2006-0075314

(51) Int. Cl. H01R 13/443

(52) U.S. Cl. 439/148

(57) ABSTRACT

A dummy plug of an option device electric connector in heavy construction equipment is disclosed, which comprises a dummy connector which has a mounting hole in an interior of a body and mounts a connection terminal into an interior of the mounting hole as the electric connector slides and is inserted along an inner wall surface of the mounting hole; and a fixing holder which is extended from a lateral surface of the body of the dummy connector and forms a circular shape at its front end and has a through hole at one side of the same wherein the dummy plug of an option device electric connector in heavy construction equipment is attached or detached from an option device electric connection.

### CROSS-REFERENCE TO RELATED APPLICATION

This application is based on and claims priority from Korean Patent Application No. 10-2006-75314, filed on Aug. 9, 2006 in the Korean Intellectual Property Office, the disclosure of which is incorporated herein in its entirety by reference.

### BACKGROUND OF THE INVENTION

1. Field of the Invention

The present invention relates to a dummy plug for an option device electric connector in heavy construction equipment, and in particular to a dummy plug for an option device electric connector in heavy construction equipment in which an electric connector is protected from dust, rain, oil, etc., and manufacturing and assembling works are enhanced by integrating a fixing holder and a dummy connector.

2. Description of the Background Art

Heavy construction equipment such as an excavator, loader, etc. is equipped with a plurality of electric connectors for wiring an option device. A dummy pin is generally inserted into a wire connection hole so that a foreign substance such as rain, dust, oil, etc. is not inputted into the interior of electric connectors, and the dummy plug is fixed at one side of equipment.

FIG. 1 is a schematic perspective view illustrating an electric connection part of an option device electric connector in conventional heavy construction equipment. As shown therein, a connection hole 2 is formed with a certain depth in the interior of an electric connection part 4 of the electric connector. An upper support shoulder 3 is protruded from an upper side of the electric connector 10.

When a corresponding electric connector 10 is manually inserted into a connection hole of the electric connector of an option device in the course of a wiring work of the option device, power and control signals are connected. So, a driver can properly perform a desired option work. The other electric connectors, which are not used for connections, are fixed with a grip as a dummy pin 5 is inserted from the backside of the electric connection part 4 of the electric connector.

However, the above wiring works additionally need the electric connection parts of an electrical connector, dummy pins and grips, so that the assembling and manufacturing works are not easy, and the unit cost increases.

According to the electric connection part of an electrical connector for a conventional option device, foreign substances such as rain, dust, oil, etc. may be inputted into the interior via the connection holes in the course of use or storage.

### SUMMARY OF THE INVENTION

Accordingly, it is an object of the present invention to provide a dummy plug of an option device electric connector in heavy construction equipment, which is able to prevent a foreign substance such as rain, dust, oil, etc. from inputting into the interior of the same.

It is another object of the present invention to provide a dummy plug of an option device electric connector in heavy construction equipment in which a fixing holder and a dummy connector are integrated and detachably attached to an electric connector, so that the manufacturing and assembling works are enhanced.

To achieve the above objects, in a dummy plug of an option device electric connector in heavy construction equipment which is attached or detached from an option device electric connection, there is provided a dummy plug of an option device electric connector in heavy construction equipment which comprises a dummy connector which has a mounting hole in an interior of a body and mounts a connection terminal into an interior of the mounting hole as the electric connector slides and is inserted along an inner wall surface of the mounting hole; and a fixing holder which is extended from a lateral surface of the body of the dummy connector and forms a circular shape at its front end and has a through hole at one side of the same.

The dummy connector is connected with an extension extended from a lateral side of the body and is integrated with the fixing holder.

An auxiliary mounting part is formed at an upper side of the body of the dummy connector so that an upper support shoulder of the electric connector slides and is inserted, and a step-shaped guide groove is formed in the interior of the auxiliary mounting part for thereby obtaining a non-contacting surface with respect to the upper support shoulder.

### BRIEF DESCRIPTION OF THE DRAWINGS

The present invention will become better understood with reference to the accompanying drawings which are given only by way of illustration and thus are not limitative of the present invention, wherein;

FIG. 1 is a schematic perspective view illustrating an electric connection part of an option device electric connector in conventional heavy construction equipment;

FIG. 2 is a schematic perspective view illustrating a dummy plug for an option device electric connector in heavy construction equipment according to an embodiment of the present invention;

FIG. 3 is a front view illustrating a dummy plug for an option device electric connector in heavy construction equipment according to an embodiment of the present invention;

FIG. 4 is a lateral view illustrating a dummy plug for an option device electric connector in heavy construction equipment; and

FIG. 5 is a view of a use state of a dummy plug for an option device electric connector in heavy construction equipment according to the present invention.

### DETAILED DESCRIPTION OF THE PREFERRED EMBODIMENTS

The dummy plug of an option device electric connector in heavy construction equipment according to the present invention will be described with reference to the accompanying drawings.

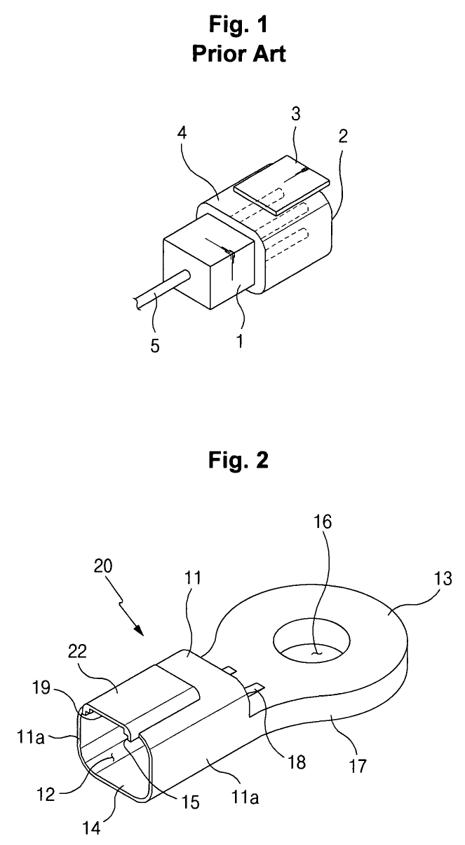

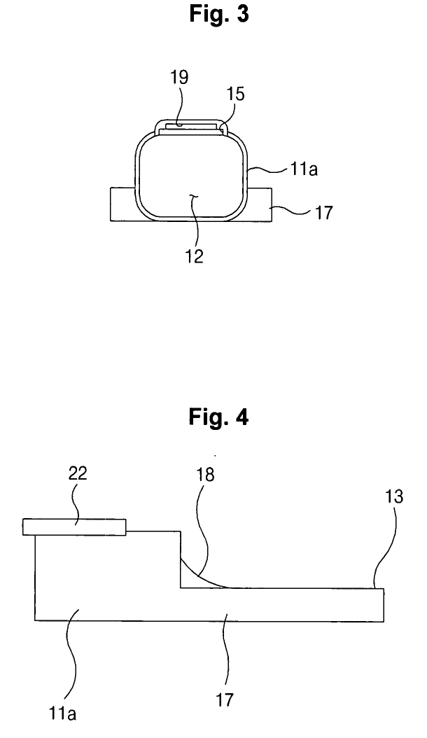

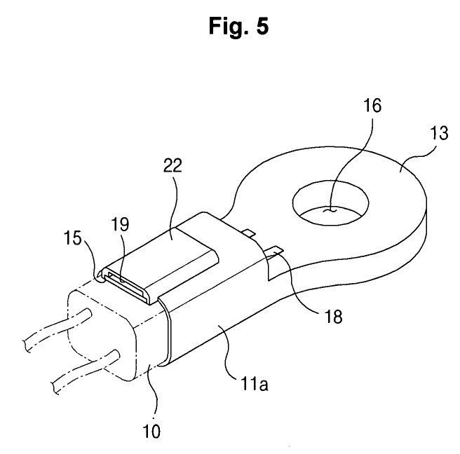

FIG. 2 is a schematic perspective view illustrating a dummy plug for an option device electric connector in heavy construction equipment according to an embodiment of the present invention. FIG. 3 is a front view illustrating a dummy plug for an option device electric connector in heavy construction equipment according to an embodiment of the present invention. FIG. 4 is a lateral view illustrating a dummy plug for an option device electric connector in heavy construction equipment. FIG. 5 is a view of a use state of a dummy plug for an option device electric connector in heavy construction equipment according to the present invention.

As shown therein, a dummy plug for an option device electric connector in heavy construction equipment according to the present invention is detachably attached to an electric connector 10 of an option device and is used as an electric connector dummy plug.

According to the dummy plug 20, a sliding mounting part 12, of which one side is open, is formed in the interior of the body 11, and an electric connector 10 slides and is inserted along an inner surface of the sliding mounting part 12, and an electric terminal 14 is mounted on an inner side of the sliding amounting part 12.

The shape of the sliding mounting part 12 of the connector 20 is determined depending on the shape of the outer surface of the electric connector 10. At least one slide surface 14 is formed in the interior.

The fixing holder 13 is extended from both sides of the body 11 of the dummy connector 20 and forms a circular shape its front end and includes a through hole 16 at one side of the same.

The through hole 16 of the holder 13 prevents movement of the dummy connector 20 when a fixing member such as a bolt, clamp, etc. is engaged.

The fixing holder 13 includes an extension 17 extended from a side surface of the body 11 to the fixing holder 13. A pair of rim parts 18 are provided at the upper side of the extension 17 and are connected with an upper surface 17a of the extension 17 from the backside 11a of the body 11 for thereby maintaining a certain support strength.

An auxiliary mounting part 22 is formed on an upper side of the body of the dummy connector so that the upper support shoulder 3 of the electric connector 10 slides and is inserted. A step-shaped guide groove 15 is formed in the interior of the auxiliary mounting part 22.

The guide groove 15 is provided for decreasing the friction surface area of the outer surface of the electric connector 10 in the course of attachment or detachment with the help of a non-contact operation as an interval groove 19 has a non-contact with respect to the upper support shoulder 3 at the upper center of the guide groove 15.

According to a preferred embodiment of the present invention, it is preferred that the dummy connector 20 and the fixing holder 13 are connected via the extension 17 and are formed in an integrated structure. They are preferably manufactured using an electrical insulation material in the course of molding.

In the description of the present invention, the corner 21 of the dummy connector 20 is preferably formed in an arc shape so that it does not directly contact with the corner of the body of the electric connector 10. It may be formed in a rectangular shape or a grooved shape depending on the shape of the body of the electric connector 10.

According to the dummy plug of an option device electric connector of heavy construction equipment according to the present invention, the body of the electric connector 10 of an option device, which is not used at usual time, is mounted on the sliding mounting part 12.

When a user inserts the electric connector 10 into the sliding mounting part 12 of the dummy connector 20 and slightly applies force thereto, since the body 1 of the electric connector 10 moves toward the backside 11a along the slide surface 14 of the sliding mounting part 12, the electric connector 10 is substantially mounted into the interior of the dummy connector 20.

The upper support shoulder 3 of the option device electric connector 10 is received into the interior of the auxiliary mounting part 22 along the guide groove 15 of the dummy connector 20.

Since the upper side of the auxiliary mounting part 22 non-contacts between the outer surface of the upper support shoulder 3 and the interval groove 19, the upper support shoulder 3 of the option device electric connector 10 is faster received into the guide groove 15 with the help of a user's insertion pressure.

Here, the inner front end of the sliding mounting part 12 is closed by means of the backside 11a, and the option device electric connector 10 keeps a sealed state in the interior of the sliding mounting part 12, so that a foreign substance such as rain, dust and oil does not input into the connection terminal 4.

The connection terminal 4 of the option device electric connector 10 can be protected in safe without corrosion or short-circuit.

When the dummy connector 20 slides and is inserted into the option device electric connector 10, a user inserts a certain insertion member such as a bolt or a clamp for thereby fixing the fixing holder 13 at one side of heavy construction equipment, so that the option device electric connector 10 and the dummy connector 20 can be stored in safe.

When a wiring work is needed for an option device depending on a work environment, a user should disassemble the dummy connector 20 and the electric connector 10 which were assembled via a sliding insertion work. Since the operations that the body 1 of the electric connector 10 and the upper support shoulder 3 are slide-disassembled easily in the reverse sequence of the assembling sequence are well known to a person who is skilled in the art, the description on the same will be omitted.

As described above, according to the dummy plug of an option device electric connector in heavy construction equipment of the present invention, an electric connector is sealed in the interior of a dummy connector, a foreign substance such as rain, dust, oil, etc. is not inputted. Namely, the dummy plug of the present invention may be kept in safe for long time. Since the fixing holder and the dummy connector are integrally formed without a grip of the conventional art, it can be easily attached or detached from the electric connector, so that the manufacturing and assembling works can be enhanced.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In a dummy plug of an option device electric connector in heavy construction equipment which is attached or detached from an option device electric connection, a dummy plug of an option device electric connector in heavy construction equipment, comprising:
a dummy connector which has a mounting hole in an interior of a body and mounts a connection terminal into an interior of the mounting hole as the electric connector slides and is inserted along an inner wall surface of the mounting hole; and
a fixing holder which is extended from a lateral surface of the body of the dummy connector and forms a circular shape at its front end and has a through hole at one side of the same.

2. The plug of claim 1, wherein said dummy connector is connected with an extension extended from a lateral side of the body and is integrated with the fixing holder.

3. The plug of claim 1, wherein an auxiliary mounting part is formed at an upper side of the body of the dummy connector so that an upper support shoulder of the electric connector slides and is inserted, and a step-shaped guide groove is formed in the interior of the auxiliary mounting part for thereby obtaining a non-contacting surface with respect to the upper support shoulder.

4. The plug of claim 3, wherein an auxiliary mounting part is formed at an upper side of the body of the dummy connector so that an upper support shoulder of the electric connector slides and is inserted, and a step-shaped guide groove is formed in the interior of the auxiliary mounting part for thereby obtaining a non-contacting surface with respect to the upper support shoulder.
